(19) United States
(12) Patent Application Publication
(10) Pub. No.: US 2002/0008026 A1
(43) Pub. Date: Jan. 24, 2002

(54) Cathode cartridge of testing device for electroplating and testing device for electroplating

(76) Inventor: Wataru Yamamoto, Tokyo (JP)

Correspondence Address: Liniak, Berenato, Longacre & White, Suite 240, 6550 Rock Spring Drive, Bethesda, MD, 20817, US

(21) Appl. No.: 09/861,898

(22) Filed: May 22, 2001

(30) Foreign Application Priority Data
May 24, 2000 (JP) 2000-152342

(51) Int. Cl. G01N 27/26

(52) U.S. Cl. 204/434

(57) ABSTRACT

To provide a cathode cartridge of testing device for electroplating which includes a dummy plate 7 as a negative pole providing in outside of a tubular front insulator 6 in case, and which can obtain a uniform plating membrane, which has an orifice having a same shape to that of plated department 2a of a plated base 2 as a negative plate, which has a plurality of a protruding portion 4 that press contact to a peripheral part of said plating base 2a, which has a tubular cathode conductor 4 exposing to connect a direct voltage source with an are that is not soak in a plating solvent, a tabular rear insulator 5 which covers a rear side of said plated base 2 and a rear said cathode conductor 4, and has a recess, into which said plated base 2 and said cathode conductor 4 get just, a tabular front insulator 6, which has an orifice having a same shape to that of said plate base 2a, and which covers a front side of said cathode conductor 4, an elastic thin board 3, which is sandwiched between said plate base 2 and a tabular front insulator 5.

### BACKGROUND OF THE INVENTION

1. Field of the Invention

The present invention relates to a cathode cartridge of testing device for electroplating and testing device for electroplating, more particularly to one, which can plate uniformly.

2. Prior Art

Recently, plating technology has been applied for a wide range of filed, especially following one is noticed as a technology to form a minute metallic object.

One of these is the wiring technology of LSI, which is so-called as Damascene Process. In order to materialize higher integration and high performance thereof, reducing a pitch of wiring distributed on a semiconductor is required. The Damascene Process is a method, in which channels for wiring are maintained after setting up layer insulation by carrying out dry etching process, and then the wiring material is bedded in said channel by plating.

Moreover, as the latest technique by using another plating technology, there is a technique called as L I G A ( Lithographie, Galvanoformung devices ) to manufacture a minute mechanical parts. L I G A is a technology which acrylic resin is treated by X-ray to be performed as molding processing and then metallic minute particles are molded out of accumulating plating deposit thickly in the mold.

In order to materialize said plating technology, accumulating with uniform plating is required for a hollow dug place of a plating material. In addition, it is required that an appropriate plating condition is chosen by carrying out tests under any kind of conditions of plating solution and current density in a small scale laboratory level to be industrialization.

And the present invention is to proved a cathode cartridge and anode cartridge of a testing device for electroplating and a testing device for electroplating which can form uniform film in a small scale testing device for electroplating.

### SUMMARY OF THE INVENTION

To solve said subjects, according to the primary object of the present invention, there is provided characterized cathode cartridge used in a testing device for electroplating, which comprises by including following items:

A tabular cathode conductor, which has an orifice having a same shape to the outline of a plating side of the plated base that is a negative plate, which has plural protruding portions that press contact to a peripheral part around the plated department, and which is able to connect with a direct voltage source by an exposed portion thereof, which is not soaked in plating solution,

A tabular rear insulator, which covers both a backside of said plate base and a backside of said cathode conductor, and has a recess, into which said plate base and said cathode conductor get just,

A tabular front insulator, which has an orifice having the same shape to that of said plate base, which covers a front side of said cathode conductor,

A elastic thin board, which is sandwiched between said plate base and said rear insulator.

Owing to the above mentioned construction, since cathode department except the plate side can be intercepted from plating solutions invading by insultor, the lines of electric force is generated from the anode to the plate base, Consequently a uniform plating membrane can be formed. And owning to the construction, in which protruding portions provided in a cathode conductor press contact to the plate base, accuracy contacting the cathode conductor with the plate base can be reached. Moreover, since multiple protruding portions provided, the lines of electric force can enter uniformly into the plate base, a uniform plating membrane can be formed. Besides, the conductor in the present invention is an electric conductor which means a metal or a carbon as example.

And, according to the second object of the present invention, there is characterized cathode cartridge of wherein claim 1 to be connected with a direct voltage source by providing a conductive dummy plat having said shaped orifice to be a negative pole.

Owning to above construction, since the lines of electric force limited to only around the plate base can enter into the dummy plate from a plate side of the plate base, the lines of electric force entering into the plate base can be uniform, consequently, a uniform plating membrane can be formed.

Furthermore, according to the third object of the present invention, there is characterized a testing device for electroplating, which comprise.

A plating tank for injecting the plating solvent,

An anode placing in said plating tank,

A cathode which is the plate base placing parallel to said anode in the plating tank,

A scupper for the plating solvent provided in a bottom of said plating tank in a testing device for electroplating equipped with a direct voltage source to apply voltage between said anode and cathode,

An exhaust hole for a plating solution provided in a bottom of a plating tank to mix around a surface of said plate base,

A circulation pump for a plating solvent to be connected in order to absorb a plating solvent from said scupper and to dispose a plating solvent from an exhaust hole.

Owning to above construction, the bubble generated on the plating department can be removed and the density of positive ion around the plating department can be invariable, consequently a uniform plating membrane can be formed.

### BRIEF DESCRIPTION OF THEDRAWING

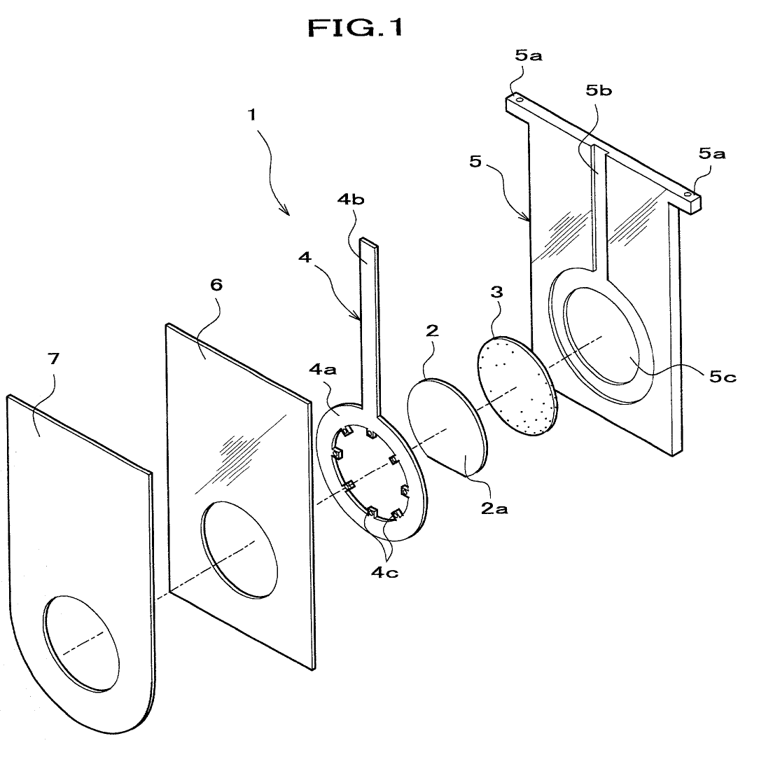

FIG. 1 is an exploded perspective drawing of the testing device for electroplating regarding to the implemented formation of this invention and a silicon wafer.

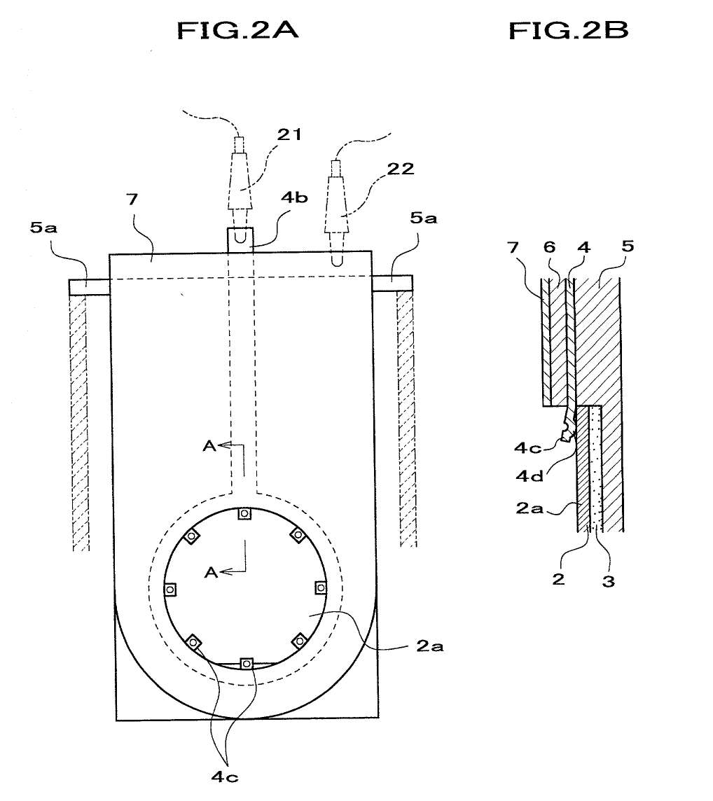

FIG. 2 (a) is a front view of the cathode cartridge of the testing device for electroplating regarding to the implemented formation of this invention and a silicon wafer, (b) is a sectional view taken on line A-A of illustration (a).

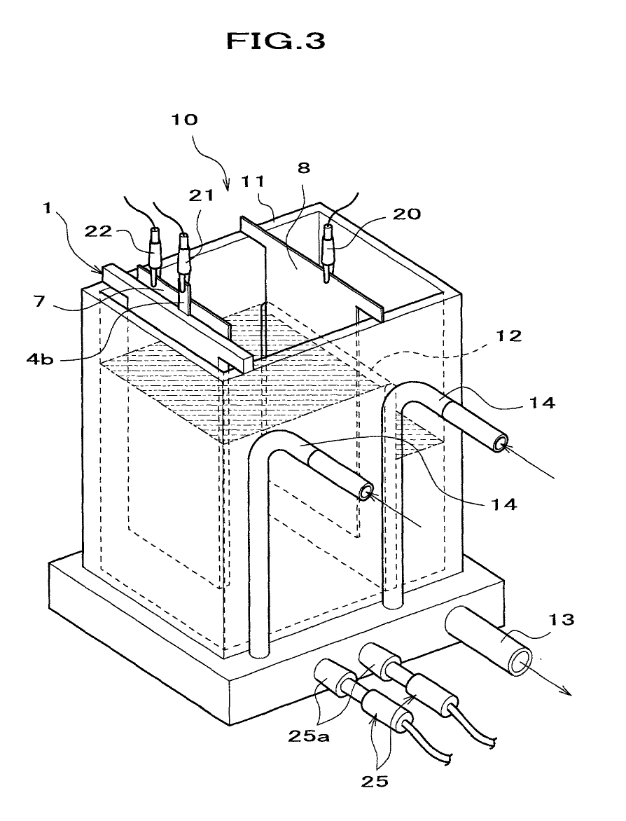

FIG. 3 is a perspective drawing to indicate an appearance of the testing device for electroplating regarding to the implemented formation of this invention.

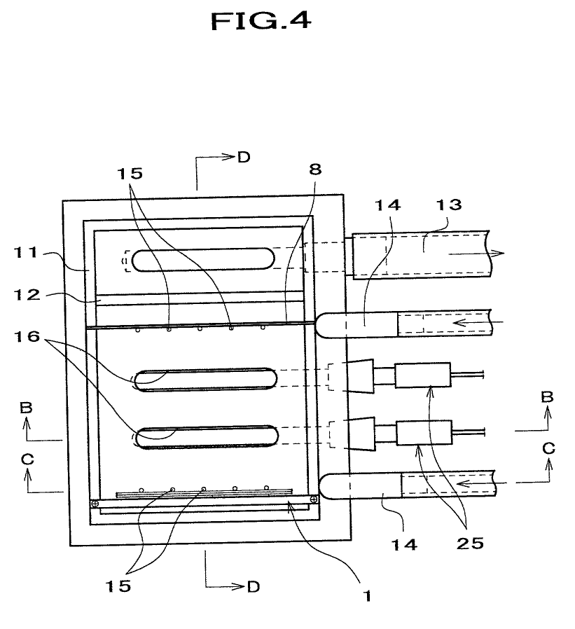

FIG. 4 is a top view of the testing device for electroplating regarding to the implemented formation of this invention.

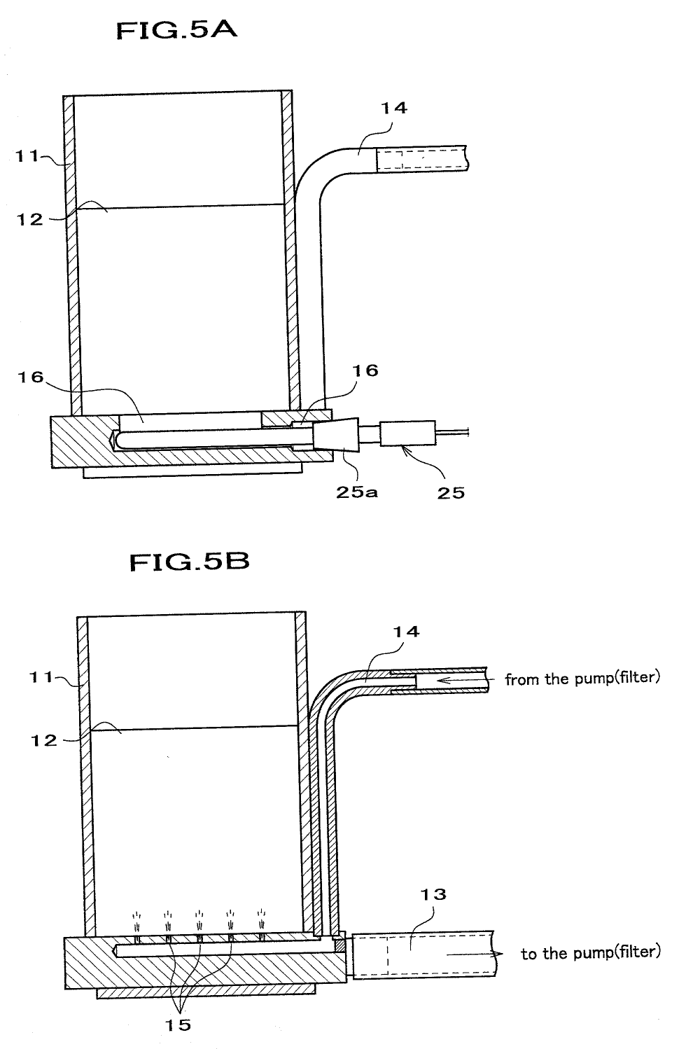

FIG. 5 (a) is a sectional view taken on line B-B of FIG. 4 of the testing device for electroplating regarding to the implemented formation of this invention, (b) is a sectional view taken on line C-C of FIG. 4.

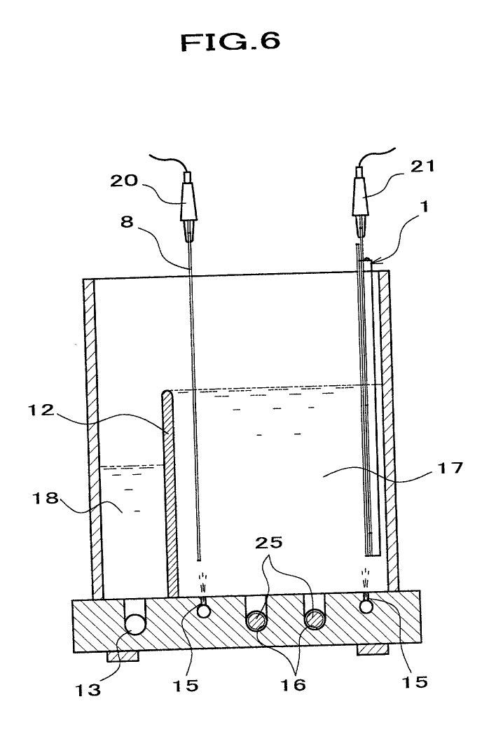

FIG. 6 is a sectional view taken on line D-D of FIG. 4 of the testing device for electroplating regarding to the implemented formation of this invention,

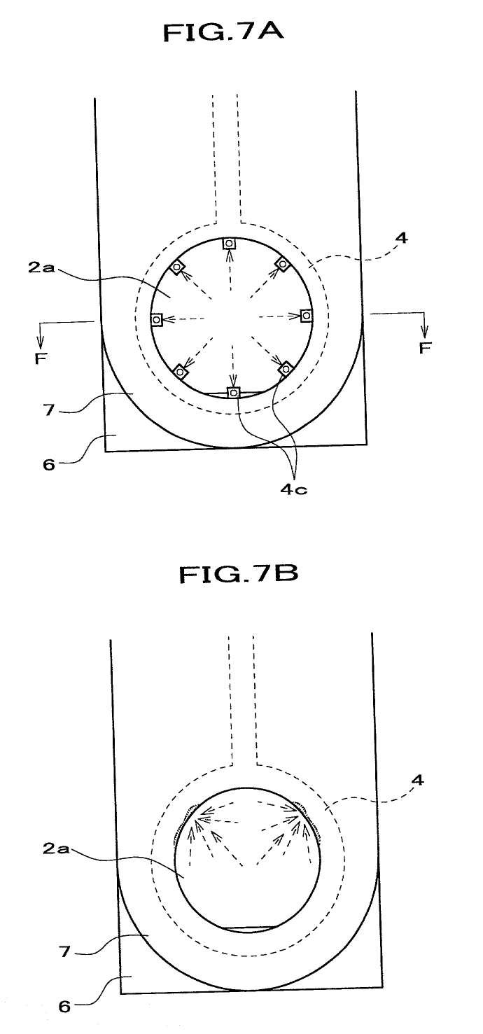

FIG. 7 (a) is a top view of the cathode cartridge regarding to this invention, (b) is a top view of the cathode cartridge without a protruding portion.

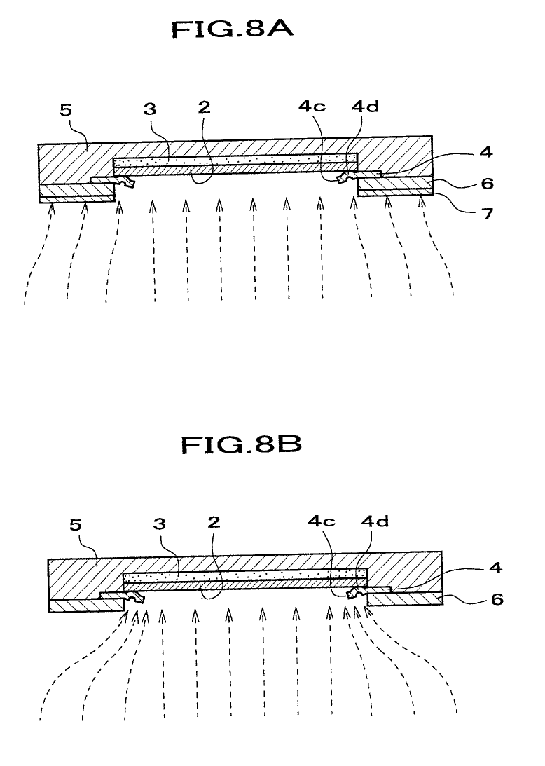

FIG. 8 (a) is a sectional view taken on line F-F of FIG. 7 (a), (b) is a sectional view taken on line F-F of FIG. 7 (a) without a dummy plate.

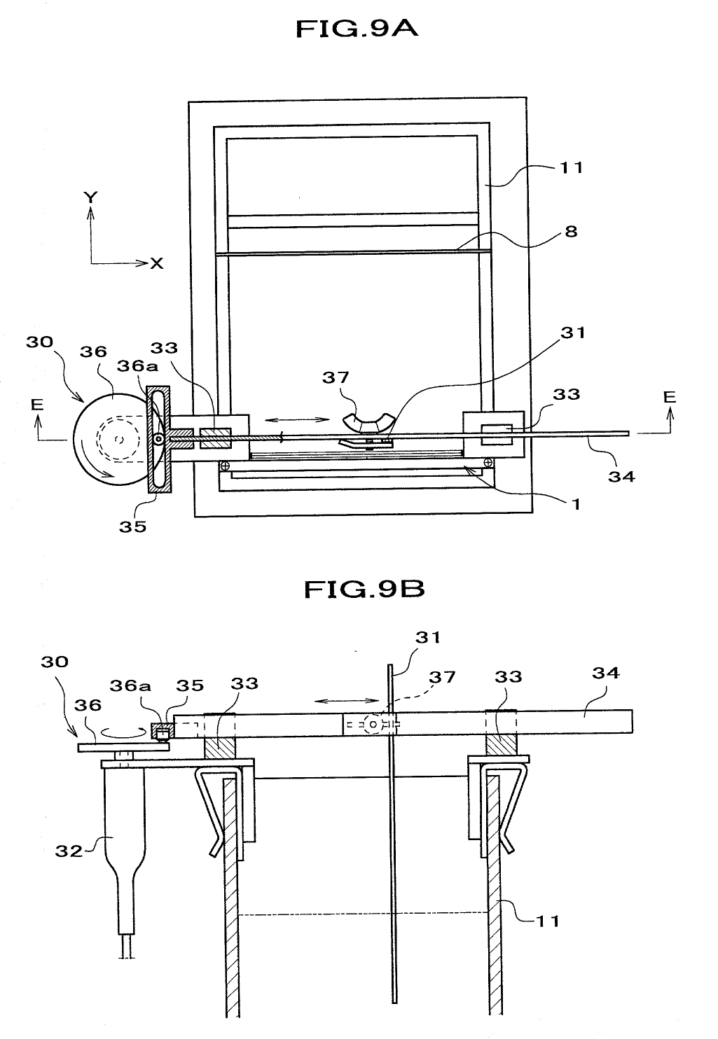

FIG. 9 (a) is a top view of equipping a mixer for the plating solvent in the testing device for electroplating of the implemented formation of this invention, (b) is a sectional view taken on line E-E of FIG. 9 (a).

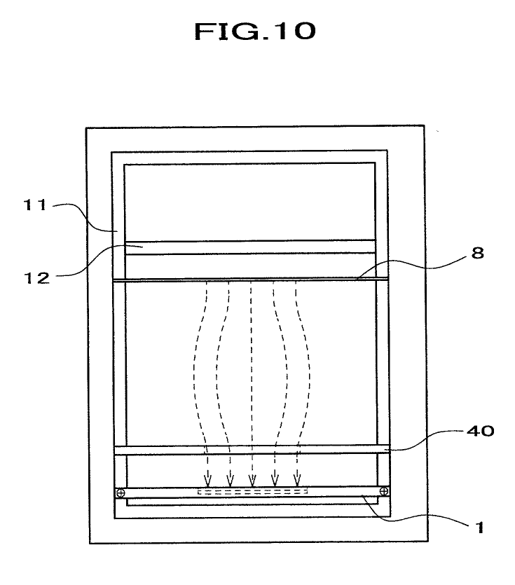

FIG. 10 is a top view of the testing device for electroplating equipped with a tubular inceptor that is an insulator around a negative pole between a cathode and an anode.

### DESCRIPTION OF THE PREFERRED EMBODIMENT

FIG. 1 is an exploded perspective drawing of the cathode cartridge of the testing device for electroplating regarding to the implemented formation of this invention and a silicon wafer. And FIG. 2 (a) is a top view of the cathode cartridge of the testing device for electroplating regarding to the implemented formation of this invention and a silicon wafer.

(b) is a sectional view taken on line A-A of illustration (a).

A cathode cartridge 1 is following construction. An elastic thin board 3 as a rubber with being elastic that is absolutely contacted with a backside of the plate department 2a so as to be intercepted from the plating solutions invading which is arranged in the direction of the reverse( called ┌a back side┘ as follows ) of a plated departments 2 of a circular thin board that is the plate base. The cathode conductor 4 comprised of a stainless thin board is arranged on the side of the plate base 2a ( called ┌a front side┘ as follows ) of silicon warfare 2. The cathode conductor 4 is comprised of the ring portion 4a having a circular shaped orifice that is almost same shape to the outline of a plated department, the power supply-connecting department 4b protruded upward over the ring portion 4a, and the contact flake 4c provided toward a center at an eight regular intervals around a circumference of the ling portion 4a. The contact flake 4c has, moreover, as illustrating FIG. 2 (b), a protruding portion 4d toward the plate deprtment 2a, and comprised as press contacting to a plating department 2a with slightly distorting.

The rear side of an elastic thin board 3 and a cathode conductor 4 are covered with a rear side of an insulator 5 of an acryl plate. The rear side of insulator 5 has a support portion 5a on the two apex of upward rectangle to hang a cathode cartridge 1 on the plating tank, and a concave portion 5b, 5c are provided in the surface in which a cathode conductor 4 and an elastic thin board 3 are contacted with each other in order to enclose these parts.

The front side insulator 6 which has an orifice that is same shape to the outline of the plate department 2a is provided in the front side of a cathode conductor 4, at the same time, the dummy plate 7 comprised of an electric conductor which has an orifice that is same shape to the outline of the plate department 2a is provided in the front side therein. The silicon wafer 2, an elastic thin board 3 and a cathode conductor 4 are sandwiched among the back side insulator 5, the front side insulator 6 and a dummy plate 7, and tight fixed all by using regin-made-scrfew( not illustrated ) from the front side of the dummy plate 7. The cathode cartrige 1 and silicon warfare 2( simply called ┌negative pole 1┘ as follows ) of which are combined together have an appearance as shown in FIG. 2(a) taken by seeing through from the plating department side 2a, in which only the plating department 2a and the supply-connecting department 4b exposed to sight from a front side of the cathode cartridge 1 and a rear side of insulator parts.

FIG. 3 is a perspective drawing to indicate an appearance of the testing device for electroplating regarding to the implemented formation of this invention, placing said negative pole 1 and positive pole 8, and installing a necessary power source, a pump and a heater. Besides in FIG. 3, the illustration of a power source and pump are omitted. And FIG. 4 is a top view of the testing device for electroplating regarding to the implemented formation of this invention, FIG. 5 (a) is a sectional view taken on line B-B of FIG. 4 of the testing device for electroplating regarding to the implemented formation of this invention, (b) is a sectional view taken on line C-C of FIG. 4, and FIG. 6 is a sectional view taken on line D-D of FIG. 4.

The testing device for electroplating 10 is comprised of the plating tank 11, the negative pole 1, positive pole 8, a heater 25, and both a circulation pump and a power source. (See to FIG. 3)

The plating tank 11 is a water tank, which consists of a transparent acrylic plate and in which there is the plating tank and a water tank 18 divided by a diaphragm 12, in which the former is lager in capacity than the latter. (see to FIG. 6) The negative pole 1 is placed by hanging a supporting portion 5a on edge of the tank of the wall facing a diaphragm 12 of a plating tank 17. The positive pole 8 is, like a negative pole, placed by hanging on the edge of the tank facing the negative pole 1 on the side of a diaphragm 12. The heater 25 is inserted into a hole 16 (see to Fig (a)) with a certain depth provided from a side position of a bottom of the plating tank 11. Besides, the entrance hole 16 for a heater is to prevent a leakage of the solvent enclosed by a rubber cook 25.

The circulating pump (not illustrated) is connected to absorb the plating solvent from a drainage hole 13 provided from a side position of a bottom of the drainage tank 18, and to send the plating solvent into an inside of the plating tank 11 from an exhaust hole 14. The power source (not illustrated) in which a positive pole is connected to a positive pole 8 by terminal 20, and a negative pole is connected to a power connecting source portion 4b by terminal 21 and a dummy plate 7 a terminal 22.

The plating solvent including positive ion such as cupper ion and so forth is poured in the plating tank 11, the plating solvent overflowed from the plating tank 17 is subject to be flowed into the drainage tank 18 by crossing over a diaphragm 12.

Like illustrating in FIG. 5 (b), the plating solvent entered from a drainage hole 14 is subject to be burst forth powerfully from an exhaust nozzle 15 that is connected to an inflow hole 14. The exhaust nozzle 15 is, like indicating in FIG. 4 and FIG. 6, bored in the bottom of the plating tank 17, which are formed respectively in line at near distance( approximately 1˜2 mm ) toward the plating department 2a of a negative pole 1 and a positive pole 8 of negative pole 1.

The cathode cartridge 1 of the testing device for electroplating and the testing device for electroplating 10, which are constituted above, are operated in the following way. First, the plating solution is poured into a plating tank 11 to a little low level than a height of a diaphragm 12. And a circulation pump (not illustrated) is switched on. A positive pole of a power source is connected to terminal 20, and the negative pole of a power source is connected to terminal 21 and 22. In this time, feed a feeble current in terminal 22 compared with terminal 21.

By operations as mentioning above, though a process of the plating to a silicon warfare 2 is started, the present invention produces following actions in the plating process.

First of all, a following is a contact point of the plating department 2a and the cathode conductor 4. FIG. 7 (a) is a top view of a cathode cartridge regarding to present invention, (b) is a top view of a cathode cartridge without a protruding portion. In FIG. 7, the arrows indicate flows of a current on the plating department. In the occasion of not constituting like a present invention, for example, when contacting a plating department 2a with a cathode conductor 4 on a peripheral part around said plated department 2a without a protruding portion 4d, only one pointed contact on a circumference is occurred as indicating in FIG. 7 (b) due to a slight deformation of parts and an unevenness of assembled parts. Consequently, since the lines of electric force eccentrically enter into around the contacting point of the plating department, only the membrane around contacting portion became thick which is a heterogeneity as whole. However, in the present invention, a narrow point of a tip of a protruding portion 4d is contacting to the plating department, the pressure of contacting surface is high, and an accuracy contact is guaranteed. Especially, in the implemented formation of the present invention, a protruding portion 4d is contacted with the plate department 2a with distorting as indicating in FIG. 2 (b), the cathode conductor 4 is certainty contacting to eight tips of circumference of the plate department 2a. Accordingly, as illustrating in FIG. 7 (a), the lines of electric force uniformly enter into the plating department 2a, the current passes equally into each contact, and consequently, a formation of uniform plating membrane is feasible.

Besides, in the present implemented formation, though treating a protruding portion 4d of a contact flake 4c as a contact point by providing a contact flake 4c around the inner circumference of a ling portion 4a of the cathode conductor 4, providing a protruding portion 4d around the ling portion 4a without a contact point 4c is also feasible as example.. In this case, the contact pressure of a contact point can be obtained by an elastic force of an elastic thin board 3.

And then, a following is an explanation of providing a dummy plate 7 in outside of front side insulator 4 to make a dummy plate 7 a negative pole. FIG. 8 (a) is a sectional view taken on line F-F of FIG. 7 (a), and (b) is a sectional view without a dummy plate taken on line F-F of FIG. 7 (a). In FIG. 8, the arrows indicate the lines of an electric force in the plating solvent.

In the case of not providing a dummy plate of a cathode, like in FIG. 8 (b), the line of an electric force in the plating solvent enter intensively toward around the plating department 2a from the side of the plating department 2a. Consequently, the thickness of the membrane around the plating department 2a tends to be increased. For this phenomenon, providing a dummy plate 7 like the present invention, the lines of an electric force approaching the plating department 2a form side directions are aspirated to a dummy plate as indicating in FIG. 8 (a). Consequently, since only the lines of electric force approaching from forward enter into the plating department 2a, a uniform plating membrane can be formed on the plating department 2a.

And next, a following is an explanation that the plating solvent burst forth from around an inflow hole 15. As for an electroplating, the plate base is a negative pole, a metallic positive ion in the plating solvent is attracted a negative pole for accumulating on the plating department. In this time, since a metallic positive ion around the plating department 2a is easily attracted, the density of a positive ion around the plating department 2a became low as time goes by. At the same time, since the condition of plating is changed, the quality of plating is changed as time goes by. Furthermore, when a gaseous positive ion in the plating solvent is attracted to a negative pole, a bubble is yield on the plating department. These cause heterogeneous plating because the current does not pass on an area of the adherence of a bubble and piling up a plating is suspended.

However, in the present invention, when a plating solvent burst flow around the plating department 2a for circulation, the density of a metallic positive ion around the plating department 2a does not change as time goes by. Moreover, for the adhesion of bubble to a plating department 2a, the plating solvent draining powerfully to a plating department 2a flush this bubble down. These agencies make it possible for the testing device for the present invention to stabilize a plating condition and to make a uniform membrane of the plating.

Above is the explanation of this implemented formation, the testing device for electroplating of the present invention is not restricted to the formation of said implementation.

For example, As applying for a method of using the testing device for electroplating of this implementation, The usage of equipping with a mixer for the plating solvent is also available.

FIG. 9 (a) is a top view of the appearance of equipping with a mixer for a plating solvent in the testing device for electroplating of the implementation of the present invention, (b) is a sectional view taken on line E-E of FIG. 9(a). Still more, in FIG. 9 (a) and (b), a drawing of a portion except for a frame portion of a plating tank 11,a mixer 30 for a plating solvent, a negative pole 1 and a positive pole 8 are omitted.

A mixer 30 for a plating solvent is to mix a plating solvent around a plating department 2a by imparting a reciprocate motion to a paddle 31 of a metallic stick having approximately 2 mm in a diameter perpendicular to an axis of a paddle along a plating department 2a on a peripheral of a plating department 2a. A paddle 31 is fixed in a slide shaft 34 with a screw 37, and a slide shaft 34 is capable for sliding on the slide rail 33 and a chennel 33 in a direction X. A follower 35 with a channel in Y diction perpendicular to a slide shaft is fixed in a edge of another slide shaft 34. A roller pin 36a is embedded in a channel of a follower 35, and a roller pin 36a is supported with universal function for revolution to a desk 36 in one area around a desk 36 rotated by a motor 32.

These constructed mixer 30 for as plating solvent acts as follow. When a motor 32 is run, a desk 36 fixed by a motor 32 rotates, the position of X and Y of roller pin 36a in a desk are changed. A follower 35 can only move in X direction, since changing the Y position of a roller pin 36a is aspirated in a channel of a follower 35, a follower 35 performs a reciprocating motion in X direction in accordance with changing a position of X direction of a roller pin 36a in a channel. A slide shaft 34 and a paddle 31 is integrally fixed, a paddle 31 performs a reciprocating motion in a X direction.

Since a mixer 30 for a plating solvent mix powerfully around a plating department 2a in above way, these make the density of a metallic positive ion around the plating department 2a invariable in addition to remove an adhesion of a bubble to a plating department 2a, Accordingly, a uniform plating membrane can be obtained on a plating department 2a.

And as another example, an insulted interceptor can be provided around a negative pole between a negative pole 1 and a positive pole 8.

FIG. 10 is a top view of the testing device for electroplating equipped with an insulted interceptor around a negative pole 1 between a negative pole and a positive pole. In FIG. 10, the arrows indicate a currency of the lines of electric force in the plating solvent.

An interceptor 40 is an insulted plate, which has a hole of a similar figure and slightly smaller than a plating department 2a, such as 5% smaller than a plating department 2a in front of a plating department 2a. This interceptor 40 is to be placed around a positive pole 1, such as the position of 10 mm ahead of the plating department 2a in order to put together a core point of hole both a plating department 2a and an interceptor 40.

The plating of this condition cause the lines of an electric force, which go out from a positive pole, can enter into ahead of the plating department 2a uniformly, because when the lines of an electric force is about to enter into a plating department after spreading over a side direction, a pass way is restricted by an interceptor 40, consequently entering into a plating department 2a from a side of the plating department is impossible. That is why, a density of a currency in a plating department 2a became a uniform, and a uniform plating membrane can be formed in a negative pole.

Like in above mentioning in detail, according to the invention of a claim 1, contacting the plating department with a cathode conductor is certainty, and a uniform plating membrane van be formed.

Furthermore, according to the invention of a claim 2, since the lines of electric force approaching to a plating department from a side of a plating department can enter into a dummy plate, the lines of electric force enter into the plating department, consequently a uniform plating membrane can be formed.

Besides, according to the invention of a claim 3, the density of a metallic positive ion around the plate department became invariable, and an adhesion of a plating department can be removed, consequently a uniform plating membrane can be formed.

What is claimed is:

1. A cathode cartridge of a testing device for electroplating, comprising:
a tabular cathode conductor, which has an orifice having a same shape to that of plated departments of a plated base as a negative plate, which has a plurality of a protruding portion that presses contact to a peripheral part around said plated departments, and which is able to connect with a direct voltage source by an exposed portion thereof, which is not soaked in plating solution,
a tubular rear insulator, which covers both a backside of said plated base and a backside of said cathode conductor, and has a recess, into which said plate base and said cathode conductor get just.
a tabular front insulator, which has an orifice having the same shape to that of the plated departments, which covers a front side of the cathode conductor,
an elastic thin board, which has a recess, into which said plate base and said rear insulator get just.

2. a cathode cartridge according to claim 1 characterized as equipped with a dummy plate which has an orifice having a same shape to that of said plated base and is connected to a direct voltage source to be a negative pole.

3. a cathode cartridge of a testing device for electroplating, comprising:
In a testing device for electroplating equipped with a plating tank for injecting a plating solvent, a positive pole placing in said plating tank, a negative pole placing parallel to said positive pole in said plating tank, and a direct voltage source to apply a voltage between said positive pole and said negative pole,
a scupper for a plating solvent, which is provided in a bottom of said plating tank,
a inflow hole for a plating solvent, which is provided in a bottom of said plating tank to mix around a surface of said plating base,
a circulation pump for a plating solvent, which is connected to aspirate a plating solvent from said scupper and to brush flow a plating solvent from said inflow hole.
